(19) United States
(12) Patent Application Publication
(10) Pub. No.: US 2025/0031719 A1
(43) Pub. Date: Jan. 30, 2025

(54) METHOD OF MAKING A FIBROUS FUNGUS-CONTAINING FOOD PRODUCT AND PRODUCTS THEREOF

(71) Applicant: PLANTED FOODS AG, Kempttahl (CH)

(72) Inventors: Colin Kofmel, Winterthur (CH); Patrick Rühs, Zurich (CH); Edwina Romanens, Luzern (CH); Lukas Böni, Zurich (CH); Judith Wemmer, Zurich (CH)

(21) Appl. No.: 18/713,848

(22) PCT Filed: Nov. 25, 2022
(86) PCT No.: PCT/EP2022/083338

§ 371 Date: May 28, 2024

(30) Foreign Application Priority Data
Nov. 26, 2021 (EP) 21210887.2

(51) Int. Cl. A23J 3/22; A23J 3/20; A23J 3/26; A23L 31/00

(52) U.S. Cl. CPC A23J 3/227; A23J 3/20; A23J 3/26; A23L 31/00

(57) ABSTRACT

A method of providing a fibrous fungus-containing food product involving the steps of providing one or more elongated pieces made from a wet textured protein product; providing nutrients for fungal growth inside or around the one or more elongated pieces; inoculating said one or more elongated pieces with at least one fungus; forming a scaffold for mycelium growth with the one or more elongated pieces; and incubating the scaffold at growth conditions that allow for mycelium growth of the at least one fungus so that the at least one fungus forms mycelium, which grows along and through the scaffold to form a fibrous fungus-containing food product.

### CROSS-REFERENCE TO RELATED APPLICATION(S)

This Application is a Section 371 National Stage Application of International Application No. PCT/EP2022/083338, filed Nov. 25, 2022 and published as WO 2023/094619 A1 on Jun. 1, 2023, in English, and claims priority to European patent application No. 21210887.2, filed Nov. 26, 2021.

### FIELD

The current invention relates to a method of providing a fibrous fungus-containing food product by providing elongated pieces of a wet textured protein product, which adhere to each other through surface growth of fungal mycelium. Thus, a fungus-containing food product is formed.

### BACKGROUND

Current meat consumption is depleting our natural resources while fuelling climate change. Our current meat consumption is unsustainable and therefore meat alternatives must be developed to counteract the ever-growing consumption of meat.

Various approaches are applied to produce meat alternative products resulting in tremendous differences in texture and nutritional value:

Tofu and some more modern products such as plant-based sausages or meat loafs are produced by gelation of watery dispersions/solutions of proteins and/or polysaccharides. This approach results in rather low protein contents not quite comparable to meat and soft, silky, springy, rather juicy textures without fibrosity comparable to animal sausage meat.

In another approach, dry textured vegetable protein (TVP), pieces of fungi, lab-grown animal cells, or mushrooms, grains, beans, nuts, or seeds are glued or sintered together, this being known from traditional products such as tempeh or more modern products such as plant-based burger patties, sausages, nuggets, minced meat, etc. In tempeh, protein-rich grains, beans, nuts or seeds are sintered by growth of a mycelium-forming fungi (e.g., Rhizopus oligosporus) in between the particles, resulting in a firm, grainy texture without fibrosity but with a protein content closer to animal meat (up to 20 g/100 g), e.g., as disclosed in https://www.thekitchn.com/how-to-make-tempeh-cooking-lessons-from-the-kitchn-202369 (accessed Nov. 1, 2021), EP 2 835 058 A1 and U.S. Pat. No. 3,885,048 A. In a similar approach, disclosed in WO 2020/232347 A1, a grain is combined with plant protein concentrate or isolate prior to sintering with a filamentous fungus. In various plant-based meat-like products, dry/porous extrudate, often referred to as dry texturized vegetable protein (“TVP”) is sintered together by a gelling agent (e.g., methyl cellulose) (Kyriakopoulou et al, Foods, 10(3), 2021) to then form products such as burgers or nuggets. In several other approaches, such TVP, extruded pellets, extruded strands or extrudate is sintered by addition of a mycelium-forming fungi as disclosed in WO 2021/030412 A1, WO 2020/164680 A1, WO 2013/087558 A1 and JP 2006 129703 A. Such porous/dry extrudate, extruded strands, extruded pellets or dry TVP provide pores or channels for the fungus to grow through and to receive sufficient oxygen and nutrients. Alternatively, WO 2021/030412 A1 suggests to produce mycelium in liquid fermentation and provide the fungal biomass obtained thereby as scaffold for fungal growth-based sintering. The final sintered products are chewy, spongy, and juicy with a structure comparable to products based on ground/minced/sausage meat but lack directed fibrosity and muscle-like structures.

Fibrous meat alternatives, such as plant-based chicken pieces, are commonly produced by high moisture extrusion cooking (HMEC) or shear cell (SC) processing, where proteins are molten under high temperature, pressure and at moisture contents of 40-80% and subsequently cooled under shear resulting in the formation of a solidified fibrous structure, as described by Osen et al. (“High moisture extrusion cooking of pea protein isolates: Raw material characteristics, extruder responses, and texture properties”, J. of Food Engineering, 127 (2014) 67-74). WO 2021/195175 A1 discloses further examples of producing fibrous meat analog using wet extrusion. Although the resulting products come close to animal meat with regard to fibrosity, the rather homogeneous and dense structures formed in these processes lack juiciness and springiness and are considered too doughy and too dense. When processing such products into small pieces such as pieces resembling chicken pieces or pulled pork, the fibrosity seems to dominate the sensory perception and the crust formed during cooking or the marinade or sauce added during cooking seem to cover doughiness and lack of juiciness. However, when biting into larger pieces, doughiness and lack of juiciness become more dominating, thus resulting in less pleasant texture. Additionally, in comparison to animal meat, such fibrous structures based on plant proteins lack fat and collagen/connective tissue phases. In animal meat, fat and connective tissue are located in between the muscle tissue and contribute to a juicier and more marble texture.

Furthermore, meat alternatives replacing larger pieces of meat (whole cuts) and juicier pieces of meat such as chicken breasts are required to satisfy consumer needs and move towards an animal-free diet and reduce the environmental footprint of the food system. However, HMEC and SC processing are limited in size to a few centimeters, typically not thicker than 3 cm, due to thermo- and fluid dynamics.

### SUMMARY

To build larger pieces of meat alternatives, which combine the pleasant fibrosity of HMEC- or SC-treated wet textured protein products but circumvent high density, doughiness, limited juiciness and limited complexity of the structure and size constraints, the current invention is proposed, which relates to a method of providing a fibrous fugus-containing food product, and an embodiment of the method can include the steps of:
(i) providing one or more elongated pieces made from a wet textured protein product produced by e.g. high moisture extrusion cooking or shear cell processing;
(ii) providing nutrients for fungal growth inside or around the one or more elongated pieces;
(iii) inoculating said one or more elongated pieces with at least one fungus;
(iv) forming a scaffold for mycelium growth with the one or more elongated pieces; and
(v) incubating the scaffold at growth conditions that allow for mycelium growth of the at least one fungus so that the at least one fungus forms mycelium, which grows along and through the scaffold to form a fibrous fungus-containing food product.

The resulting fungus-containing food product shows meat-like fibrosity from the fibrous elongated pieces or bundles, while the fungal mycelium at the interfaces of the pieces makes up connective tissue comparable to a complex animal meat structure. This method further results in a product with lower density than the initial wet textured protein product, thus decreasing the unpleasant dense and doughy texture.

Surprisingly, the product texture as well as the taste can be tailored by changing the distance between the adjacent elongated pieces, the available nutrients and the growing conditions. For example, if the distance between two elongated pieces is larger, mycelium growth results in a weaker adhesion in between the elongated pieces. Adequate nutrient availability, strain, composition of the elongated pieces and growing conditions can even lead to a pleasant aroma formation. The amphiphilicity and the porous structure of the mycelium furthermore allow to absorb oil and water into the interstitial space between the elongated pieces resembling fat tissue and/or connective tissue in animal meat. The liquid phase in the interstitial space is released during mastication and thus contributes to juiciness.

Even more surprisingly, when coating the elongated pieces with carbohydrates, e.g. glucose-rich agar and/or starch, or adding carbohydrate-based pieces, e.g. starch-based pieces, or glucose-rich agar strands, in between the elongated pieces, fungal growth in the interstitial space is enhanced, the pieces adhere better and the remaining starch in the interstitial space contributes to a sliminess after cooking, which is comparable to collagen or connective tissue found in animal meat in between muscle fibers. Such a structure interconnected with a collagen/fat-like matrix has so far not been achieved in plant/fungi-based meats. Furthermore, when supplying carbohydrates on the surface of or in between the elongated pieces, the fungus metabolizes the carbohydrates rather than the proteins, thus reducing the formation of ammonia and protecting the texture of the elongated pieces.

In other words, according to one aspect of the present invention, a lack of directed fibrosity in known products may be addressed by providing elongated pieces of wet textured protein product, assembling such pieces into a scaffold with a fibrous structure in a way that the fungus grows through the scaffold, binding the elongated pieces together, e.g. as in a muscle-like fashion. Such muscle-like structures are highly desired by consumers as they remind more of high-value cuts of animal meat as compared to “minced-like products”.

As fungal growth requires oxygen and certain humidity and temperature conditions, it is challenging to provide adequate conditions for fungi to grow through a larger body. However, large pieces of meat-like fibrous food products are desired by consumers to satisfy the need for whole cuts, such as products resembling beef tenderloin or chicken breast. Surprisingly, in the current invention, this limitation can be overcome by putting tubes into the scaffold. Optionally, the tubes communicate an inner part of the scaffold with the surrounding environment, allowing air transportation from the surrounding environment to the inner part of the scaffold. Optionally, the tubes are oxygen-permeable and/or conducting tubes, such as plastic tubes with small holes. Alternatively, rods may be placed into the scaffold, which are then optionally removed after an initial incubation period, thus creating channels for increasing oxygen permeability at a point in time, when the scaffold is partly filled with mycelium and the oxygen concentration may have already decreased in the core due to fungal activity.

Even more surprisingly, the tubes or needles inserted into the scaffold can be connected to a source of pressurized gas, such as pressurized air or pressurized oxygen or to a pump in order to press or pump oxygen-containing gas into the core. Thus, large pieces of at least 10 cm in shortest dimension can be produced with mycelial growth throughout the scaffold. Interestingly, these rods, needles or tubes also help to avoid overheating in the core, which is required to ensure ideal growth conditions for the fungus.

The term “fungus-containing” means that the product obtained by the method always contains fungal components, in particular fungal mycelium, while other ingredients may vary in origin.

Embodiments of the method of the present invention can be performed such that in step (i) elongated pieces are provided. The term “provided” in this context means that elongated pieces are used or that such elongated pieces are prepared. Means and methods for preparing the elongated pieces are described further below.

“Anisotropic” refers to the internal structure of the elongated piece. Optionally, the elongated pieces each comprise an anisotropic internal structure, also referred to as “fibrous structure”, which is a result of the wet texturization process, such as high moisture extrusion cooking or shear cell processing, e.g., as described in R. Osen, Dissertation, 2017 (https://d-nb.info/116838026X/34) or K. Grabowska, Food Research International, 64, 2014. These processes result in a fibrous internal structure substantially aligned in direction of the flow field. As in high moisture extrusion cooking and in shear cell processing, the protein-containing matrix is mixed with water and heated to above 100° C. and subsequently solidified under shear, a fibrous structure is being formed as known to a person skilled in the art. For the present invention, pieces are provided with an elongated shape, meaning that one dimension is substantially longer than the other two dimensions (e.g., a “strand”) or two dimensions are substantially longer than the third dimension (e.g., a “sheet”). Importantly, the longest dimension or one of the longest dimensions is optionally substantially aligned to the fibrous internal structure. This feature of the elongated pieces in combination with fibrous structure is advantageous to create a highly fibrous texture and appearance in the final product.

The term “fibrous structure” refers to a structure in which fiber bundles/fiber aggregates/aggregated fibers/fiber sheets, in particular consisting of proteins, result in anisotropy characteristics regarding structure and mechanical properties of the fibrous structure. Optionally, the fibrous structure has a high degree of alignment in one direction. The fibrous structure is formed in the wet texturization process as proteins and other components are stretched and/or aligned by application of shear. The fibrous structure is comprised of multiple fiber bundles/fiber aggregates/aggregated fibers/fiber sheets, sometimes referred to as “fibers”. The fibrous structure resulting from wet texturization is known to a person skilled in the art and results in a chewy, animal meat-like texture and appearance.

Optionally, the elongated pieces are composed of wet textured protein product, which is made by wet texturization through e.g. high moisture extrusion cooking or shear cell processing. Wet texturization means that a protein-containing formulation is mixed with a water phase, optionally subjected to a temperature of above 100° C. under shear, followed by cooling under shear which results in the formation of a fibrous structure. Wet texturization, in particular, refers to texturization at a water content of 40-80 wt %. In contrast, dry/porous extrudates, TVP, and extruded pellets, as utilized for example in WO 2020/164680 A1 or WO 2021/030412 A1, are processed in a way that a porous structure results. As pointed out in WO 2021/030412 A1, TVP for example is produced by extruding a molten protein mixture through a die to cause a rather sudden pressure release at the extruder exit, resulting in a less fibrous, more spongy structure. The moisture content in extrusion to form such structures is typically below 35-40 wt % to reach sufficiently high pressure and to provide sufficient coherence of the mixture upon expansion. Such approaches do not result in structures with the desired, muscle-like directed fibrosity achieved with the present invention. Remarkably, in wet textured protein products, the fibers are substantially aligned due to the controlled cooling and solidification under flow, which is of particular importance for the present invention.

Optionally, said wet textured protein product are produced by high moisture extrusion cooking in an extruder, optionally in a twin-screw extruder, at a moisture content of above 40 wt % and below 80 wt %, optionally between 45 wt % and 70 wt %, and at a protein content of above 10 wt %, optionally above 15 wt %, optionally above 20 wt %. In particular, the mixture of protein, water and other components is sheared and heated in the extruder to above 100° C., optionally above 120° C. and subsequently cooled in a cooling die to below 100° C. before exiting the machine to avoid puffing and form a fibrous structure. The elongated pieces are then prepared from the wet textured protein product.

In an alternative method, the elongated pieces are produced by fiber spinning or 3D printing.

In particular, said wet textured protein product comprises at least 10 wt % protein, optionally at least 15 wt %, optionally at least 20 wt % protein selected from the group consisting of pea, soy, wheat, sunflower, fava, pumpkin, rice, cereals, pulses, oil seeds, algae, single cells, fungi, and fermented components or a mixture thereof.

“Protein” refers to protein isolate, concentrate or flour or combinations thereof, which may also contain other macronutrients, such as carbohydrates, fats, dietary fibers, salts, or residual water. Said isolate, concentrate, flour or combination thereof optionally contains a pure protein content of at least 40 wt %, optionally at least 50 wt %, optionally at least 60 wt %. The protein isolate, concentrate or flour (“protein”) could also be referred to as a “protein composition” or “protein powder” in the context of the present invention. Optionally, said protein also comprises sufficient carbohydrates to act as a nutrient source for the fungus.

In one embodiment, said wet textured protein product comprises pea protein as the only protein source.

In an alternative embodiment, said wet textured protein comprises pea protein as well as at least one other protein source, optionally from plants.

In an alternative embodiment, said wet textured protein product comprises at least pea protein, sunflower protein and oat protein.

In an alternative embodiment, said wet textured protein product comprises at least pea protein and yeast protein.

In an alternative embodiment, said wet textured protein product comprises at least pea protein and soy protein.

In an alternative embodiment, said wet textured protein product comprises soy protein as the only protein.

Besides water and proteins/protein compositions/protein powders, the wet textured protein product may comprise any other edible components which are added prior to or during the wet texturization process, such as oil or fat, dietary fibers, flavour components, colorants, or carbohydrates, wherein the other components are optionally from non-slaughtered origin, optionally originating from plants, fungi, fermentation processes, lab-grown animal cells, or single cell organisms.

Optionally, one of the elongated pieces is made from one formulation of wet textured protein product, while another of the elongated pieces is made from another formulation of wet textured protein product, or there might be more than 2 differently formulated elongated pieces used for one scaffold.

The elongated pieces may be made from the wet textured protein product by means of cutting, pulling, rolling or by soaking in liquid to an extent that the fibrous protein product disintegrates into anisotropic fibrous pieces, but not limited to these methods. In particular, the fibrous structure is substantially aligned to the longest dimension of the elongated piece. “Substantially aligned” means that thinner fiber bundles can be peeled off from an elongated piece in the direction of the longest dimension.

For example, the wet textured protein product produced by high moisture extrusion cooking may be peeled or cut in the alignment direction of the fibrous structure into strips or sheets representing the elongated pieces.

Optionally, the elongated pieces are prepared in a way that the longest dimension thereof is at least 2 times longer, optionally at least 5 times longer than the other two dimensions thereof (i.e., the other two dimensions that are (i) orthogonal to the longest dimension and (ii) orthogonal to each other).

Optionally, said elongated pieces are in the shortest dimension, e.g., diameter, not larger than 2 cm, optionally not larger than 1 cm, optionally not larger than 0.5 cm, optionally not larger than 0.3 cm. Optionally, said elongated pieces are in the longest dimension, e.g., length, not less than 1 cm, optionally not less than 2 cm, optionally not less than 4 cm. The resulting fibrous fugus-containing food product closely resembles meat structure when the elongated pieces have dimensions falling within the above ranges.

Optionally, the elongated pieces are further processed prior to inoculation including but not limited to soaking or cooking in water at 0-120° C., soaking in an acidic or alkaline solution, drying, compressing or smoking. In particular, the water activity or the moisture content of the elongated pieces is adjusted to the conditions desired for fungal growth, optionally the water activity is between 0.8 and 1.0, optionally between 0.9 and 1.0, optionally between 0.96 and 1. Optionally, the pH of the elongated pieces is decreased to below 7, optionally below 6, optionally below 5 to support growth of the fungus. This may be achieved by spraying acid, such as lactic acid, acetic acid, citric acid or other acids, on the surface of the elongated pieces or by soaking said elongated pieces in acid.

The elongated pieces may be dried to reach a water content of below 40 wt %, optionally below 30 wt % before incubation.

Optionally, at least one of the elongated pieces is differently further processed than at least one other elongated piece. In particular, some elongated pieces may be dried more than one or more other elongated pieces or soaked in liquid for a time longer than one or more other elongated pieces. Further, some elongated pieces may be treated with an edible inhibitor of fungal growth, such as essential oils, while other elongated pieces used in the same scaffold are not treated with fungal growth inhibitors.

Optionally, part of the elongated pieces is processed differently than the other part of the elongated pieces.

Optionally, the elongated pieces are sterilized or pasteurized prior to inoculation to ensure inactivation of co-existing microorganisms on the surface. For example, the elongated pieces may be sterilized in an autoclave at up to 135° C.

Optionally, the surface of the elongated pieces is treated by an acid, optionally a food-grade acid, optionally lactic acid, acetic acid, malic acid, citric acid or succinic acid, optionally to reach a pH of below 6, optionally below 5, optionally not above 4.6 at the surface. Optionally, the pH on the surface is adjusted to ensure growth of the utilized fungus and to reduce growth of other microorganisms.

Nutrients, such as carbohydrates, optionally starch or sugar, may be provided inside or on the surface of the elongated pieces as a nutrient, such as by adding starch- or sugar-containing ingredients to the high moisture extrusion cooking or shear cell process, or by soaking the wet textured protein product or the elongated pieces in a starch or sugar solution, or by coating the elongated pieces with starch- or sugar-containing liquid or powder. Optionally, at least 1 wt % nutrients are comprised, optionally at least 2 wt % nutrients are comprised, optionally at least 5 wt % nutrients are comprised based on a total weight of the one or more elongated pieces. Such starch-containing ingredients added to the wet texturization process may be protein flour, protein concentrate or protein isolates, which contain starch or sugar residues.

Optionally, said nutrients are selected from the group of carbohydrates, including mono-, di, oligo-, or polysaccharides acting as nutrients for the respective fungus, optionally selected from the group of starch, glucose, sucrose, or malted starch.

Alternatively or additionally, said nutrients may be selected from the group of proteins or fats or oils.

Optionally, said nutrients are a mixture of carbohydrates, also referred to as saccharides, with protein and/or fats or oils.

Optionally, said starch is swollen or pre-gelatinized prior to coating or the starch-coated elongated pieces are heat-treated to cause swelling and gelatinization on the surface of the elongated pieces.

Starch refers to native, untreated, malted, modified, pre-gelatinized or other types of starches or starch derivatives, optionally selected from the source of rice, wheat, maize, root vegetables, such as potatoes or cassava.

Sugar refers to any mono-, di-, or oligosaccharide, which can be metabolized by the fungal metabolism, in particular sugar may refer to glucose, sucrose, and maltose.

Optionally, the surface of the elongated pieces is at least partly coated with carbohydrate, optionally starch prior to incubation to an extent that the carbohydrate or starch is not fully metabolized by the fungus, optionally with at least 2 wt % carbohydrate or starch, optionally with at least 5 wt % carbohydrate or starch, optionally at least 10 wt % carbohydrate or starch. Said starch may be pre-gelatinized or party or fully swollen, for example by heat treating the starch-coated elongated pieces.

Said carbohydrate may be cellulose and/or hemicellulose and may be in form of plant fibers, e.g., citrus fibers, banana fibers, bamboo fibers, oat fibers, carrot fibers, apple fibers, microcrystalline cellulose or microfibrillated cellulose, wherein said plant fibers may further comprise lignin or other plant components.

“Not fully metabolized” means that some of the carbohydrate or starch remains on the surface of the elongated pieces or in the fungal mycelium network in between the elongated pieces at the point when fungal growth is terminated or when the final product is consumed. Optionally, the remaining carbohydrate, optionally starch contributes to a slimy, collagen-like mouthfeel.

Alternatively or additionally, the elongated pieces may be coated with hydrocolloids, optionally agar, carrageenan, pectin, gelatin, xanthan, gellan gum or alginate or a combination thereof, prior to inoculation and/or incubation. Optionally, a hydrocolloid is chosen that is not at all or not fully metabolized during incubation.

Such hydrocolloid may also be combined with starch, glucose, sucrose, malted starch or other carbohydrates, such as in glucose-rich agar.

Optionally, any added components, such as nutrients, are sterilized or pasteurized or treated by chemical or physical means to an extent that microbial load is sufficiently reduced to avoid spoilage during incubation prior to inoculation.

The elongated pieces, and optionally all other pieces, e.g., starch-based pieces, may be inoculated with at least one fungus by mixing with a fungus-containing liquid or powder, wherein said fungus is optionally selected from the group consisting of ascomycetes, basidiomycetes, deuteromycetes, oomycetes, and/or zygomycetes, in particular edible species belonging to the genus Rhizopus, Aspergillus, Penicillium, Ganoderma, or Pleurotus, more specifically, the species Rhizopus oligosporus, Rhizopus delemar, Rhizopus oryzae, Aspergillus oryzae, Aspergillus luchuensis, Aspergillus sojoe, Penicillium nolgiovense, Penicillium camemberti, Penicillium roqueforti, Ganoderma lucidum, Pleurotus ostreatus, Pleurotus eryngii, or a combination thereof. The surface of the elongated pieces may be prewetted prior to inoculating with fungus-containing powder.

At least 3 elongated pieces may be assembled with or without a mold to form a scaffold. The distance between neighbouring pieces may be adjusted by vibration or by applying pressure or vacuum so that each piece is at a distance of not more than 2 mm to at least one neighbouring piece, optionally not more than 1 mm, optionally not more than 0.5 mm. Said neighbouring piece may be an elongated piece or another element, for example a starch-based piece. Each elongated piece may be in contact with at least one other elongated piece or other elements, for example a starch-based piece.

At least 5, optionally at least 10 elongated pieces may be substantially aligned in the fibrous body making up a bundle of elongated pieces. The scaffold may be composed of several bundles not being aligned to each other.

The elongated pieces may be strands or sheets. Optionally, the scaffold is formed by assembling a plurality of strands into a bundle, rolling-up one or more sheets into a tube or a multilayer roll, or folding or stacking one or a plurality of sheets into a stack. Fibers and sheets may be combined in the same scaffold.

Carbohydrate-based pieces, optionally starch-based pieces may be provided and added into the scaffold, optionally said carbohydrate-based pieces being placed in between two or several elongated pieces. Optionally, said carbohydrate-based pieces comprise a carbohydrate selected from the group of starch, starch derivates, agar, alginate, carrageenan, pectin, konjac gum or sugar or a combination thereof. Optionally, said starch-based pieces each comprise at least 5 wt % starch, optionally at least 10 wt %, optionally at least 20 wt % starch based on the weight of that starch-based piece. Optionally, one of the comprised carbohydrate is gelled and/or gelatinized, thus allowing to form a piece.

Said carbohydrate-based, optionally starch-based pieces may be in the form of, e.g., cubes, rods, cylinders, sheets or stripes.

Said carbohydrate-based pieces may be plant fibers comprising cellulose and/or hemicellulose, such as citrus fibers, banana fibers, bamboo fibers, oat fibers, carrot fibers, apple fibers, microcrystalline cellulose or microfibrillated cellulose.

The starch-based pieces may be made from at least water and starch gelatinized by being heated above the gelatinization temperature. For example, starch may be mixed with water at a ratio between 1:5 to 5:1. The carbohydrate-based or starch-based pieces may optionally be cut.

The carbohydrate-based or starch-based pieces may have a thickness of 2 cm or less, optionally 1 cm or less, optionally 5 mm or less, optionally 2 mm or less. The carbohydrate-based or starch-based pieces may be provided by forming a carbohydrate- or starch-containing composition into a layer having a thickness of 2 cm or less, optionally 1 cm or less. The layer may then be cut into pieces.

For example, said starch-based pieces may be produced by mixing starch with water at a ratio between 1:5 to 5:1, optionally between 1:1 and 2:1, forming the mixture into a layer of below 1 cm in thickness and heating the mixture to a temperature of above the gelatinization temperature of starch, optionally above 60° C., optionally above 70° C., optionally above 80° C. Said temperatures cause gelation of the starch and a reduction of microbial count. Said layer may be cut into cubes or rods or stripes or sheets which are, optionally, not larger than 3 times the size of the elongated pieces.

For example, said starch-based pieces may be starch-containing noodles or pasta.

The carbohydrate-based pieces may further comprise a water, lipids, proteins and flavouring or colouring components.

Differently processed or treated elongated pieces may be assembled into a scaffold to create a gradient in pH or in nutrients throughout the scaffold. For example, elongated pieces with a higher nutrient concentration may be placed in the centre of the scaffold, while pieces with a lower nutrient concentration may be placed on the outside of the scaffold. Pieces with a lower nutrient concentration may be placed between regions of pieces with a higher nutrient concentration to create intended breaking points and differentiate sections in the body. Differently coloured pieces may be placed in groups in different regions of the body.

Alternatively, the elongated pieces may be combined with another material, being pieces or a continuous phase to fill one or several spaces between the elongated pieces. Optionally, such material has different textural properties than the elongated pieces. Such material may for example be a solution, paste, suspension, emulsion or a foam, whereas said material comprises a carbohydrate. Optionally, the solution, suspension, emulsion, gel or foam comprises a thickening agent or gelling agent to form a layer in between the elongated pieces resembling connective tissue. The comprised carbohydrates may be selected from the group of agar, carrageenan, konjac, starch, alginate, pectin or other carbohydrates.

All pieces may be substantially aligned in the scaffold, thus that the internal fibrous structure of the elongated pieces is substantially aligned. Alternatively, three or more pieces may be assembled substantially aligned to form a fiber bundle, which is in turn assembled with one or more other fiber bundles. Several fiber bundles together may form the scaffold. The two or more fiber bundles may be substantially aligned or not aligned to mimic the muscle structure of animal meat. The two or more fiber bundles may be in direct contact or separated by a layer of other pieces, for example starch-based pieces, resembling the layer of connective tissue between muscle bundles in animal meat.

The two or more fiber bundles may differ in the nature of the three or more elongated pieces they are made up of in terms of directionality, hardness, elasticity, texturization, colour, moisture content, growth nutrient composition, flavour, dimensions, surface coating, and raw material of the elongated pieces.

Optionally, pressure or vacuum is applied when assembling the elongated pieces and other pieces or fiber bundles to form a scaffold. The pressure may be applied manually or by means of machines. Pressure optionally is applied to an extent that the density of the scaffold remains lower than the average density of the elongated pieces.

Optionally, the scaffold, prior to incubation, is at least 1 cm in at least one dimension, optionally at least 2 cm, optionally at least 4 cm, optionally between 4 cm and 15 cm; and/or optionally in the shortest dimension not larger than 30 cm, optionally not larger than 20 cm.

Optionally, the scaffold is incubated at a temperature between 4 and 70° C., in particular between 1° and 50° C., optionally between 14° C. and 20° C. or between 22° C. and 38° C., for minimum 2 hours, in particular for minimum 12 hours, in very particular for the minimum duration required until mycelium is visible on the surface of the elongated pieces by human eye. Optionally, the incubation time is short enough to avoid sporulation of the fungus and/or formation of a fruiting body. Incubation may thus be terminated prior to sporulation of the fungus or prior to formation of a fruiting body.

Optionally, a scaffold inoculated with mold, such as Aspergillus oryzae, Rhizopus oligosporus, Rhizopus delemar, or Rhizopus oryzae, is incubated at 10° C. to 45° C. and a scaffold inoculated with other fungi is incubated at temperatures between 10° C. and 45° C., optionally between 22° C. and 38° C. for ascomycetes, deuteromycetes, oomycetes, and/or zygomycetes. A scaffold inoculated with basidiomycetes may be incubated at a temperature between 14 and 20° C.

In an alternative embodiment, basidiomycete species such as Ganoderma spp., or Pleurotus spp. Can be used as inoculum.

The incubation temperature refers to the temperature set in the incubator.

Optionally, the incubation temperature is adjusted as a function of the metabolic heat production through fungal growth, such that the temperature of the scaffold, referred to as substrate temperature, does not increase to above 45° C. during incubation. For a scaffold inoculated with Aspergillus oryzae, Rhizopus oligosporus, or Rhizopus oryzae, the substrate temperature is optionally kept at between 25° C. and 45° C. by regulating the incubation temperature.

Irrespective of other incubation conditions, the water activity in the scaffold optionally is in the range of 0.8 to 1.0, optionally between 0.9 and 1.0, optionally between 0.96 and 1.0. Optionally, such water activity is maintained throughout the incubation.

The preferred oxygen concentration throughout incubation may depend on the fungus.

The scaffold may be wrapped in an outer layer, wherein said layer may have holes or may be semipermeable or permeable to oxygen. Optionally, said outer layer is plastic foil, for example cling film based on polyethylene, with holes, optionally said outer layer is permeable for oxygen but not permeable for water.

The scaffold may be incubated by covering the scaffold in a material, optionally wherein the oxygen permeability coefficient of the material is below 1 but above 0. In particular, the scaffold may be wrapped in cling film.

Alternatively or additionally, micro-aerobic conditions may be created by incubating the scaffold in a space with an oxygen concentration at below the oxygen concentration in environmental atmosphere. For example, oxygen concentration may be in the range of 4000 to 10000 ppm for the scaffold, for example for a scaffold inoculated with R. oligosporus.

Optionally, holes and/or channels are made into the scaffold prior to or during incubation, to provide sufficient oxygen for fungal growth.

Optionally, one or more placeholders may be put into the scaffold during assembly of the scaffold or prior to or during incubation in order to provide for such one or more holes or channels.

Such placeholder(s) may provide for the holes and/or channels into or through the scaffold.

For example, one or more tubes or one or more rods, as examples of such placeholder(s), may be put into the scaffold prior to or during incubation. The tubes or rods may extend in any direction, such as axially or radially. Optionally, the tubes or rods extend along the shortest dimension of the scaffold.

The tubes or rods may be straight or curved.

The one or more rods or tubes may have any cross-sectional shape, for example round or polygonal (e.g., squared). The one or more rods may be solid and/or devoid of a lumen.

The placeholder(s) (e.g., tubes or rods) optionally have a diameter or width (i.e., perpendicular to their longitudinal extension) of at least 0.1 mm, optionally at least 1 mm, optionally at least 2 mm.

The placeholder(s) (e.g., tubes or rods) optionally are in the shortest dimension or width not larger than 15 mm, optionally not larger than 10 mm, optionally not larger than 5 mm.

The placeholder(s) (e.g., one or more rods) may be pulled out of the scaffold before the start of incubation or before the end of incubation. In this manner, one or more channels may be formed in the scaffold along which the oxygen can diffuse during incubation.

The one or more tubes may have a lumen extending therethrough, e.g. for conveying oxygen into the scaffold. The one or more tubes may be at last partly permeable to oxygen and/or may comprise one or more openings along a portion thereof that is inserted into the scaffold. For example, one or more of the tubes may be a hollow needle. The one or more tubes may remain in the scaffold during incubation.

The one or more tubes may connect the inner part of the scaffold with the surrounding, in particular during incubation. In this manner, a higher oxygen concentration in the inner part of the scaffold may be provided, in particular when compared to a scaffold incubated without tubes or channels.

The one or more tubes may be removed during or after incubation. Optionally, the one or more tubes are edible. In this case, the one or more tubes may not have to be removed prior to consumption.

The one or more tubes may be covered with a protective culture or an antifungal material preventing the fungus from growing into the tubes.

Alternatively, the tubes may be fully or partly metabolized by the fungus during incubation and do not require to be removed prior to consumption.

Optionally, the one or more tubes are connected to an oxygen source, optionally to pressurized air or pressurized oxygen or to a pump. The oxygen source optionally provides an oxygen-containing gas.

Optionally, the oxygen-containing gas is humidified prior to being conveyed (e.g. pumped) into the scaffold. Optionally, the one or more rods or tubes are inserted prior to or at the beginning of incubation.

Optionally, the one or more rods or tubes are removed after at least 2 hours of incubation, optionally after at least 6 hours of incubation, optionally after at least 10 hours of incubation, or optionally when mycelial growth in the scaffold is visible by eye. Optionally, the one or more rods or tubes are removed at a point in time when the hole or cavity left behind from the rod or tube is not fully disappearing after removing the rod or tube.

The tube or tubes may be interconnected and may be used to supply nutrients to the fungus during incubation by pumping nutrients into the scaffold and removing waste products.

The placeholder(s) may be branched. For example, the placeholder(s) have a branched shape which resembles a shrub or a tree in form.

The rod or tube or other placeholder may be added during assembly of the scaffold such that the scaffold is assembled around the placeholder. Optionally, the placeholder has a hole or is porous, such as a porous solid. Said porous solid may be an open-porous structure resembling bone. The open-porous placeholder communicates the inner part to the outside during incubation to allow gas exchange and oxygen supply during incubation and may later acts as a bone-like material in the final food product. The open-porous placeholder may be connected to an oxygen source, such that the oxygen-containing gas is pumped into the scaffold through the “bone-like material”. This allows to grow meat-like structure at a bone-like structure in place. Such placeholder may remain within the food product until consumption.

In an alternative embodiment, the atmosphere in and surrounding the scaffold during incubation is modulated to support fungal growth of the specific fungus or fungi, for example the composition is changed and/or the gas pressure is increased and/or fluctuated to ensure a sufficiently high oxygen concentration throughout the scaffold.

Optionally, the scaffold is incubated at least until mycelium is visible by human eye. Optionally, incubation is terminated prior to spore formation. The incubation conditions and time may be adjusted to the fungal strain, the available nutrients, the composition of the elongated pieces and to the desired result. Optionally, the incubation conditions are adjusted to avoid formation of unpleasant off-flavors, such as resulting from formation of ammonia.

Optionally, fungal growth is interrupted, optionally by changing the temperature and/or water activity to below or above the temperature and water activity conditions required for growth of the at least one fungus. Alternatively, fungal growth may be interrupted by decreasing oxygen concentration to below the critical level required by the respective fungus to grow. Optionally, fungal growth is interrupted by heating the fungus-containing product to above 60° C., optionally above 80° C., optionally above 90° C., whereas the temperature is measured in the centre of the product and is kept for at least 1 min.

Alternatively, the fungal growth is not interrupted. Instead, the fungus-containing product is stored in the fridge or freezer until consumption and is optionally consumed prior to sporulation or spoilage.

Following the described method, a fungus-containing food product is obtained.

Optionally, the fungus-containing food product as obtained by any of the variations discussed above is exposed to a liquid so that the food product absorbs the liquid, wherein said liquid is water-based or lipid-based or a combination thereof.

Optionally, at least 2 wt % water, referring to the weight after water addition, optionally at least 5 wt % water, optionally at least 10 wt % water is added to the fungus-containing food product after or prior to interrupting fungal growth and with or without heating the water to up to 99° C. Surprisingly, the water is absorbed by the fibrous pieces, resulting in swelling and thus in a reduced piece-to-piece-distance.

Optionally, at least 1 wt % of a lipid phase, referring to the weight after lipid addition, optionally at least 2 wt % lipid phase, optionally at least 5 wt % lipid phase, optionally at least 10 wt % of a lipid phase is absorbed into the fungus-containing food product. Optionally, the lipid phase is absorbed into the mycelium-filled void space, e.g. mostly absorbed into said void space. For example, lipid absorption may take place during pan frying or priorly. Lipid absorption may be provided at room temperature or at an elevated temperature in case of fat with higher melting temperature, optionally at a temperature above the melting temperature of the lipid. The lipid may be a fat or an oil. Optionally, said lipid is from a slaughter-free origin, including but not limited to plants, algae, fermentates, or lab-grown fat cells. Said lipid may solidify after absorption into the mycelial network to form a solid phase in between the elongated pieces. Solidification may be caused by reduction in temperature or by enzyme treatment.

The liquid may be enriched with flavour compounds, colorants, viscosifiers, fibers, vitamins, enzymes, trace elements, salts, acids, bases, fat, carbohydrates, polysaccharides, and/or proteins.

Additionally or alternatively, the absorbed liquid alters the pH of the fungus-containing food product, optionally the pH is reduced, optionally the pH is reduced to an extent that the shelf-life of the fungus-containing food product is longer than without alteration of the pH, and/or optionally with alteration of the pH growth conditions are made selective towards the inoculated strain or strains and/or unwanted microbial growth is prevented.

The liquid absorption may be further achieved by application of vacuum or pressure or pressure fluctuations. The absorption of water-based and lipid-based liquids may be performed in parallel or in any sequence, at same or different temperatures. The absorbed liquid may also be an emulsion comprising both water-based and lipid-based liquids or alternatively, if water-based and lipid-based liquid are absorbed separately, they may form an emulsion in the interstitial phase.

Optionally, the liquid absorbed into the fungus-containing food product is at least partly staying in the interstitial space between the elongated pieces until consumption, referred to as free liquid. The free liquid, in contrast to the liquid diffusing into the elongated pieces, can be pressed out of the fungus-containing food product and leaves the fungus-containing food product upon mastication, thus contributing to the perception of juiciness. Optionally, at least 10 wt % of the absorbed liquid is free liquid, optionally at least 20 wt %, optionally at least 50 wt %.

In an alternative embodiment, the absorbed liquid hydrates, solubilizes or liquifies a part or all of the non-metabolized carbohydrates and/or hydrocolloids surrounding the elongated pieces. Thus, the absorbed liquid gets a higher viscosity or even gels in the interstitial space. In particular, after absorbing the liquid into the interstitial space and bringing the liquid in contact with the non-metabolized carbohydrates and/or hydrocolloids, such as agar or starch, the fungus-containing food product may be heated and cooled to gel the liquid with the carbohydrates or hydrocolloids in the interstitial space, referred to as “gelling in place”. This may provide an additional phase resembling the collagen phase in an animal meat product. When heating the fungus-containing foods product prior to consumption, the gel in the interstitial space melts or liquifies again giving the perception of meat juice released during cooking or consumption.

The obtained fungus-containing food product may be cut and/or pulled into pieces or slices and/or compressed to mimic the shape of meat products.

Alternatively or additionally, the obtained fungus-containing food product may be washed in liquid water, water steam or oil.

Alternatively or additionally, the obtained fungus-containing food product may be dried prior to further use.

Alternatively or additionally, the obtained fungus-containing food product may be marinated, spiced, smoked, cured, dehydrated, or post-processed in any other way as typically done with animal meat products.

The obtained fungus-containing food product may be cut into pieces, optionally mixed with nutrients and/or more elongated pieces, optionally re-shaped or molded, and then incubated again to permit further mycelial growth.

The fungus-containing food product may comprise a scaffold and mycelium of at least one fungus growing along and through the scaffold, the scaffold being formed by one or more elongated pieces of a wet textured protein product. The wet textured protein product optionally has a protein content of at least 10 wt %, optionally at least 15 wt %.

Optionally, a first force required to pull the fibrous fungus-containing food product apart is lower than a second force required to pull the wet textured protein product apart. Optionally, the first force in this context is a force applied transversely to a longitudinal direction of an elongated piece, or the first force is a force peeling the fibrous fungus-containing food product apart along a direction parallel to a longitudinal direction of an elongated piece. Optionally, the wet textured protein product comprises a fibrous structure in which fibers are substantially aligned with each other, wherein the second force in this context is a force applied transversely to an extending direction of the fibers, or the second force is a force peeling the wet textured protein product apart along the extending direction of the fibers.

Optionally, the density of the fungus-containing food product is lower than the density of the wet textured protein product, optionally the density of the fungus-containing food product being not higher than 1 g/cm³, in particular directly after incubation and prior to a subsequent step of absorbing a liquid into the food product or drying the food product.

Optionally, the oil absorption capacity of the fibrous fungus-containing food product is higher than that of the wet textured protein product, optionally the oil absorption capacity of the fibrous fungus-containing food product being at least 5%, optionally at least 10% of its own weight.

Optionally, said fungus-containing food product is capable of absorbing at least 10% of its own weight in oil or water or a mixture of oil and water.

The fungus-containing food product optionally comprises elongated pieces of a wet textured protein product interconnected with fungal mycelium with a protein content of at least 10 wt %, optionally at least 15 wt %, and at least 0.1 wt % starch in between the elongated pieces.

Optionally, the fungus-containing food product is at least in one dimension larger than the wet textured protein product. Optionally, if prepared from wet textured protein product produced by HMEC, said fungus-containing food product is in all three dimensions larger than a thickness of the HMEC wet textured protein product, wherein said thickness of the HMEC wet textured protein product is given by the height of the cooling channel.

Optionally, the fungus-containing food product comprises of at least 3 elongated pieces, optionally at least 5, optionally at least 10.

Optionally, the fungus-containing food product comprises at least two different phases that are visible by human eye, wherein one phase is substantially composed of elongated pieces and one phase is not substantially composed of elongated pieces, optionally wherein the latter phase comprises fungal mycelium, optionally wherein the latter phase comprises fungal mycelium and starch or lipid.

Optionally, the fungus-containing food product further comprises flavour components, colorants, spices, herbs, salt, acid or other food ingredients to tailor taste and appearance.

Optionally, the fungus-containing food product shows substantial shape stability and browning on the surface when subjected to dry heat and oil, e.g., during baking or frying, comparable to a piece of animal meat.

Optionally, said the fungus-containing food product has at least two differently appealing phases that are visible by human eye, wherein one phase is substantially composed of elongated fibrous pieces and one phase is not substantially composed of fibrous elongated pieces, optionally wherein the latter phase comprises fungal mycelium, in very particular the latter phase comprises fungal mycelium and carbohydrate, for example starch, or lipid.

Optionally, said fungus-containing food product resembles animal meat products, optionally, the colonized scaffold forming said fungus-containing food product resembles animal muscle-like structures.

The terms “comprising”, “comprises” and “comprised of” as used herein are synonymous with “Including” or “Includes”; or “containing” or “contains” and are inclusive or open-ended and do not exclude additional, non-recited members, elements, or steps. The terms “comprising”, “comprises” and “comprised of” should be understood to encompass a specific embodiment in which these terms are interpreted as being close ended, as the term “consisting of”.

As used herein the term “about” means approximately, in the region of, roughly, or around. When the term “about” is used in conjunction with a numerical value or range, it modifies that value or range by extending the boundaries above and below the numerical value(s) set forth. In general, the term “about” is used herein to modify (a) numerical value(s) above and below the stated value(s) by 10%. Wherever the term “about” is used, it should be understood that also the specific value (i.e., without the term “about”) is disclosed.

In this application, a number of documents including patent applications are cited. The disclosure of these documents, while not considered relevant for the patentability of this invention, is herewith incorporated by reference in its entirety. More specifically, all referenced documents are incorporated by reference to the same extent as if each individual document was specifically and individually indicated to be incorporated by reference.

The present summary is provided only by way of example and not limitation. Other aspects of the present invention will be appreciated in view of the entirety of the present disclosure, including the entire text, claims, and accompanying figures.

### BRIEF DESCRIPTION OF FIGURES

FIG. 1 depicts rectangular pieces before incubation (left) and rectangular pieces bound into a coherent body by mycelium after incubation (right) according to Example 1.

FIG. 2 depicts a stress response of cylindrical food products in uniaxial compression, whereas the six different scaffolds differ in the fungus used for binding and in nutrient supply, according to Example 2.

FIG. 3 depicts a schematic of the preparation of substrate before incubation for Example 3. Two pieces were sandwiched between two petri dishes. a=petri dishes, b=rectangular pieces, c=defined gap between rectangular pieces.

FIG. 4 depicts a stress-strain diagram of a uniaxial tensile test of two pieces as shown in FIG. 3 after being fused by mycelium at distances of 0, 1, and 2 mm. The results indicate a higher binding strength at lower initial distance between the pieces.

FIG. 5 depicts oil uptake of samples of loose unbound elongated pieces and elongated pieces bound through mycelium from R. oligosporus showing that the oil absorption capacity increases with mycelium compared to only wet textured protein product.

FIG. 6 depicts water uptake of samples of loose unbound elongated pieces and elongated pieces bound through mycelium from R. oligosporus and A. oryzae showing a higher water uptake with mycelium compared to only wet textured protein product.

FIG. 7 depicts the fibrous food product after incubation, wherein the starch pieces are incorporated into the structure and bound to the elongated pieces by mycelium. The food product comprises elongated pieces and gelatinized starch strips. A cross section perpendicular to a longitudinal direction of the elongated pieces is shown.

FIG. 8 depicts a sketch of the assembly of elongated pieces and starch-based pieces into an anisotropic body.

FIG. 9 depicts the food product of Example 6 comprising elongated pieces and starch-based pieces, shown after frying in a pan with oil, showing that the inner structure is fibrous, and the starch pieces provide a stable collagen-like layer in between the fibrous pieces.

FIG. 10 depicts elongated pieces with varying thickness and aspect ratio bound into food products to create different textures as described in Example 7.

FIG. 11 depicts a stress-strain diagram of elongated pieces with varying thickness bound into food products measured under uniaxial compression as described in Example 7.

FIG. 12 depicts a sideview schematic indicating how, exemplarily, rods or tubes may be placed into the generally cylindrical scaffold with a=radial insertion, b=axial insertion

FIG. 13 depicts the scaffold before incubation with rods of 4 mm in diameter radially placed into the scaffold, as described for sample (iii) in Example 8, wherein a=metal rods, b=generally cylindrical body.

FIG. 14 depicts a magnification of the core of the food product after fermentation, wherein oxygen was conveyed into the core during fermentation. The magnification shows good mycelial growth in the cavities between the elongated pieces (white/bright cavities) indicating sufficient oxygen supply, as described in Example 9; a=mycelial growth in the cavities, b=elongated pieces.

FIG. 15 depicts a magnification of the core of the food product after fermentation, wherein no oxygen was conveyed into the core during fermentation. The magnification shows no or only weak mycelial growth in the cavities between the elongated pieces (black/dark holes) indicating insufficient oxygen supply, as described in Example 9; a=no or only weak growth in the cavities, b=elongated pieces.

While the above-identified figures set forth one or more embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps, and/or components not specifically shown in the drawings.

### DETAILED DESCRIPTION OF ILLUSTRATIVE EMBODIMENTS

### EXAMPLES

### Example 1

A wet textured protein product produced by high moisture extrusion cooking (HMEC) was provided comprising 10 wt % glucose as fungal nutrient and 25 wt % pea protein isolate, 15 wt % pea fibers and 50 wt % water and cut into elongated pieces with a rectangular cross-section of 2-4 mm×2-4 mm and a length of at least 90 mm. The pea protein isolate content of 25 wt % corresponds to a pure protein content of 20 wt %. The wet textured protein product in all examples was produced by high moisture extrusion cooking in a twin-screw extruder at a water content of above 40 wt % and a temperature of above 120° C. followed by cooling down in a cooling die to below 100° C. before exiting the die. The elongated pieces were inoculated by homogenously covering their surfaces with a powdered starter culture through mechanical mixing at a concentration of 4.8×10⁴ viable spores per g substrate. The starter culture comprised Rhizopus oligosporus spores and organic rice flour and had a spore concentration of 8×10¹ viable spores per g. The inoculated elongated pieces were then arranged parallel in a cylindrical form and held together by a PVC pipe acting as a mold, thereby forming a scaffold. The scaffold was incubated in a fermenter (Hera Cell240i) at a temperature of 30° C., and a relative humidity of 95% for 38 h. While the pieces had to be held together by a mold prior to incubation, the pieces adhered to each other after incubation through mycelial growth fed by nutrients available in the pieces.

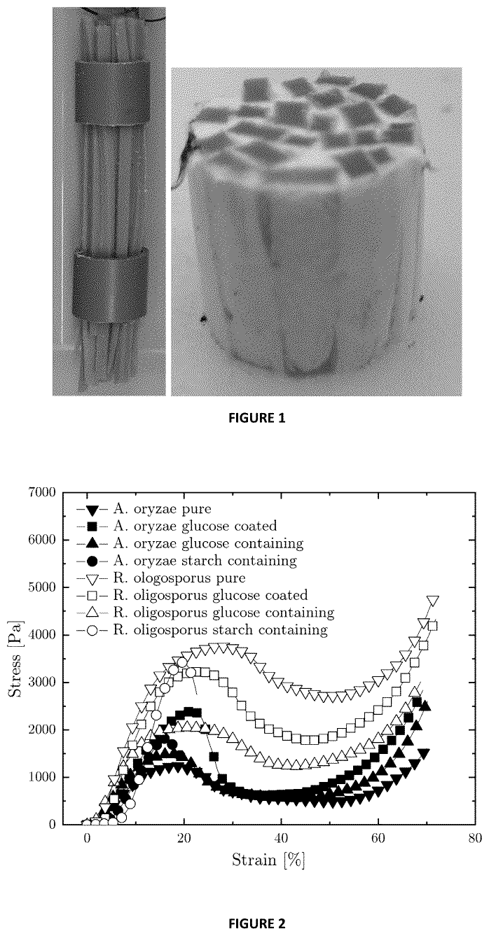

FIG. 1 shows the pieces prior to incubation (left) and after incubation (right). After incubation the product can be cut into pieces without loss of adherence. The elongated pieces and the mycelium-containing phase can be clearly distinguished by eye.

### Example 2

Four different elongated pieces were prepared all at a size of 2-4 mm×2-4 mm×90 mm:
(i) Starch-containing elongated pieces made from wet textured protein product produced by HMEC comprising 12 wt % corn starch and 25 wt % pea protein isolate, 15 wt % pea fibers, and 48 wt % water
(ii) Glucose-containing elongated pieces made from wet textured protein product produced by HMEC comprising 10 wt % glucose and 25 wt % pea protein isolate, 15 wt % pea fibers, and 50 wt % water
(iii) Elongated pieces made from wet textured protein product produced by HMEC comprising 25 wt % pea protein isolate, 15 wt % pea fibers, and 60 wt % water
(iv) Elongated pieces as in (iii) surface-coated with glucose to achieve the same glucose concentration as in (ii) but potentially with higher availability

Said elongated pieces were inoculated with either Aspergillus oryzae or Rhizopus oligosporus. Inoculation was carried out by homogenously covering all surfaces with powdered starter culture through mechanical mixing at a concentration of 4.8×10⁴ viable spores per g substrate for Rhizopus oligosporus and 3×10⁵ for A. oryzae. The starter culture either comprised Rhizopus oligosprus spores and organic rice flour with a spore concentration of 8×10⁶ viable spores per g or Aspergillus oryzae and pregelatinized starch with a spore concentration of 7-9×10⁸ spores per g. Said inoculated pieces were assembled into a cylindrical scaffold with a diameter of 20 mm according to Example 1 and incubated in a fermenter (Hera Cell240i) at a temperature of 30° C., and a relative humidity of 95% RH for 38 h.

The resulting products with a diameter of approximately 20 mm were cut into samples of 20 mm in height and compressed with a flat plane in the longitudinal direction of the elongated pieces in a texture analyzer (TA.XT Plus, Stable Micro Systems) at a compression speed of 0.5 mm/s. Uniaxial compression in said direction of the piece caused buckling of the elongated pieces. Thus, the stress response during buckling was dependent on the binding strength of the mycelium in between the pieces. As shown in FIG. 2, samples prepared with Rhizopus oligosporus showed overall a higher stress response indicating stronger binding. Samples prepared according to (i) showed lowest adherence and instead crumbled into pieces upon compression, indicating that the mycelium did not bind the pieces as well as with glucose or without additional nutrient provided. Thus, the texture of the resulting food product can be tailored by adjusting nutrients and choice of fungus according to customer needs. The densities of the resulting fibrous bodies were below 1000 kg/m³ as summarized in Table 1, while the elongated pieces have a solid density of above 1000 kg/m³.

TABLE 1
Densities of cylindrical fibrous bodies of Example 2

| | density | std |
|---|---|---|
| name | [kg/m³] | [kg/m³] |
| R. oligosporus glucose | 850 | 16 |
| containing | | |
| R. oligosporus pure | 853 | 16 |
| R. oligosporus glucose | 914 | 17 |
| coated | | |
| R. oligosporus starch | 932 | 7 |
| containing | | |
| A. oryzae glucose | 869 | 33 |
| containing | | |
| A. oryzae glucose | 939 | 45 |
| coated | | |
| A. oryzae pure | 856 | 20 |
| A. oryzae starch | 928 | 11 |
| containing | | |

### Example 3

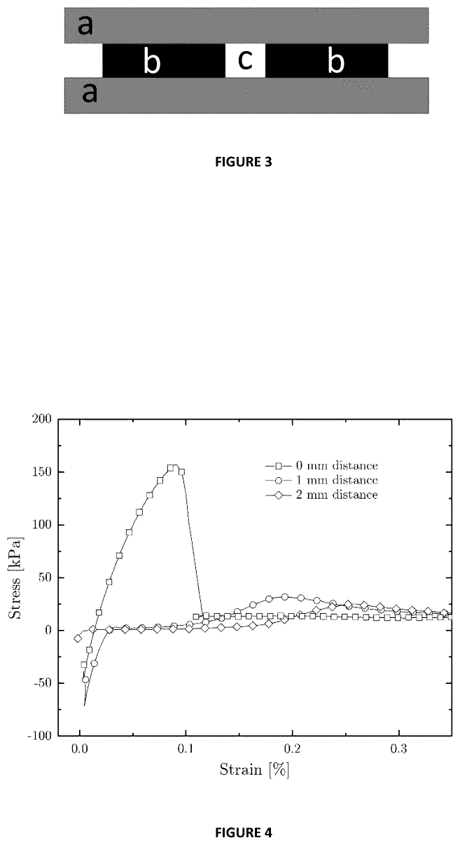

Pieces with dimensions 5×7×13 mm were cut from a wet textured protein product produced by HMEC comprising 30 wt % soy protein concentrate, 10 wt % pea fibers, and 60 wt % water, resulting in a pure protein content of 20 wt %. The pieces were coated with glucose solution to reach a glucose concentration of 10 wt % and subsequently inoculated by homogenously covering their surfaces with a powdered starter culture through mechanical mixing at a concentration of 4.8×10⁴ viable spores per g substrate. The starter culture comprised Rhizopus oligosprus spores and organic rice flour at a spore concentration of 8×10⁶ viable spores per g. Two pieces were arranged on a petri dish with their radial cross-section facing as shown on FIG. 3. The distance between the two pieces was adjusted to 0 mm, 1 mm, or 2 mm. A second petri dish was laid on top of the pieces to prevent warping of the pieces. The petri dish with the assembled pieces was incubated in a fermenter (Hera Cell 240i) at 95% RH, 30° C. for 39 h.

After incubation, the two facing pieces were fused at the facing sides through mycelium growth. Tensile tests were carried out on an Anton Paar Dynamic Mechanical Analyzer MCR 702 MultiDrive at an extension rate of 1% s⁻¹ to assess the adherence between the two pieces. As shown in FIG. 4, the stiffness decreased with increasing distance between the pieces, while the strain at rupture increased with increasing distance, both indicating a tighter mycelial network and better adherence at lower distance.

### Example 4

Oil absorption of wet textured protein products produced by HMEC was compared between pieces bound by mycelium, i.e., the food product according to the invention, and pieces without mycelium binding, i.e., the pure wet textured protein product.

Two different samples were prepared all at a size of 2-4 mm×2-4 mm×90 mm according to samples (ii) and (iii) in Example 2.

Said samples were inoculated with Rhizopus oligosporus. Inoculation was carried out by homogenously covering all surfaces with powdered starter culture through mechanical mixing at a concentration of 4.8×10⁴ viable spores per g. The starter culture comprised Rhizopus oligosprus spores and organic rice flour with a spore concentration of 8×10⁶ viable spores per g. Said inoculated pieces were assembled into cylindrical scaffolds with a diameter of 20 mm according to Example 1 and incubated in a fermenter (Hera Cell240i) at a temperature of 30° C., and a relative humidity of 95% RH for 38 h. The resulting products were bound through mycelium, had a diameter of approximately 20 mm, and were cut into samples of 20 mm in height.

Additionally, control groups of mycelium-free loose unbound pieces at a size of 2-4 mm×2-4 mm×20 mm were prepared from the same wet textured protein product as samples (ii) and (iii) in Example 2. The weight of the control groups was adjusted to match the weight of the mycelially bound cylindrical bodies produced from the pieces (ii) and (iii).

The samples were tested for oil absorption by submerging the prepared pieces in sunflower oil for 120 min and measuring their weight before and after soaking. The control groups without fungal binding fell apart during the test, while the products bound through mycelium remained whole. As shown in FIG. 5, oil absorption was increased in the mycelially bound products. Thus, the interstitial space in the product improves oil uptake. Without wanting to be bound by theory, it is believed that this effect can be employed to increase juiciness, mouthfeel and flavour in a consumer product.

### Example 5

Water absorption of wet textured protein product produced by HMEC was compared between pieces bound by mycelium, i.e., the food product according to the invention and pieces without mycelium binding, i.e., the pure wet textured protein product.

Elongated pieces were prepared all at a size of 2-4 mm×2-4 mm×90 mm from wet textured protein product produced by HMEC comprising 25 wt % pea protein isolate, 15 wt % pea fibers, and 60 wt % water. Said fibrous pieces were inoculated with either Aspergillus oryzae or Rhizopus oligosporus. Inoculation was carried out by homogenously covering all surfaces with powdered starter culture through mechanical mixing at a concentration of 4.8×10⁴ viable spores per g substrate for Rhizopus oligosporus and 3×10¹ for A. oryzae. The starter culture either comprised Rhizopus oligosprus spores and organic rice flour with a spore concentration of 8×10⁶ viable spores per g or Aspergillus oryzae and pregelatinized starch with a spore concentration of 7-9×10⁸ spores per g. Said inoculated pieces were assembled into cylindrical scaffolds with a diameter of 20 mm according to Example 1 and incubated in a fermenter (Hera Cell240i) at a temperature of 30° C., and a relative humidity of 95% RH for 38 h. The resulting products were bound through mycelium, had a diameter of approximately 20 mm, and were cut into samples of 20 mm in height.

Additionally, control groups of mycelium-free loose unbound elongated pieces at a size of 2-4 mm×2-4 mm×20 mm were prepared from the same wet textured protein product as the mycelium-bound samples, which were produced by HMEC comprising 25 wt % pea protein isolate, 15 wt % pea fibers, and 60 wt % water. The weight of the control group was adjusted to match the weight of the cylindrical bodies bound by mycelium produced from the elongated pieces.

The samples were tested for water absorption by submerging the prepared products in distilled water for 14 min and measuring their weight before and after soaking.

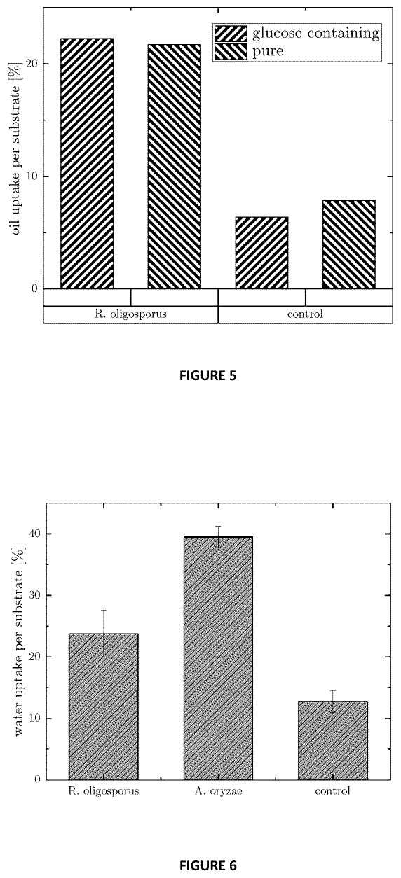

Control groups without fungal binding fell apart during the test, while the products bound through mycelium remained whole. As shown in FIG. 6, water absorption was increased through mycelial binding of the pieces. Thus, the interstitial space in the product improves water uptake. Without wanting to be bound by theory, it is believed that this effect can be employed to increase juiciness, mouthfeel and flavour in a consumer product.

### Example 6

Wet textured protein product comprising more than 20 wt % pea protein isolate and 10 wt % sunflower protein concentrate, 10 wt % pea fibers, and 60 wt % water was pulled into pieces in the range of 2-7 mm×2-7 mm×40-80 mm and mixed with pregelatinized potato starch powder to reach a starch concentration of 10 wt %. The starch-coated pieces were pasteurized in a vacuum bag in a 95° C. water bath for 25 minutes. As the heat treatment led to partly swelling of the starch granules, the pieces were partly glued together. The pieces were loosened, inoculated by homogenously covering their surfaces with a powdered starter culture through mechanical mixing at a concentration of 4.8×10⁴ viable spores per g substrate. The starter culture comprised Rhizopus oligosporus spores and organic rice flour and had a spore concentration of 8×10⁶ viable spores per g. Said pieces were assembled into a sausage-like shape with a directionality of the respective pieces parallel to the length of the sausage-like shape, leading to an elongated structure.

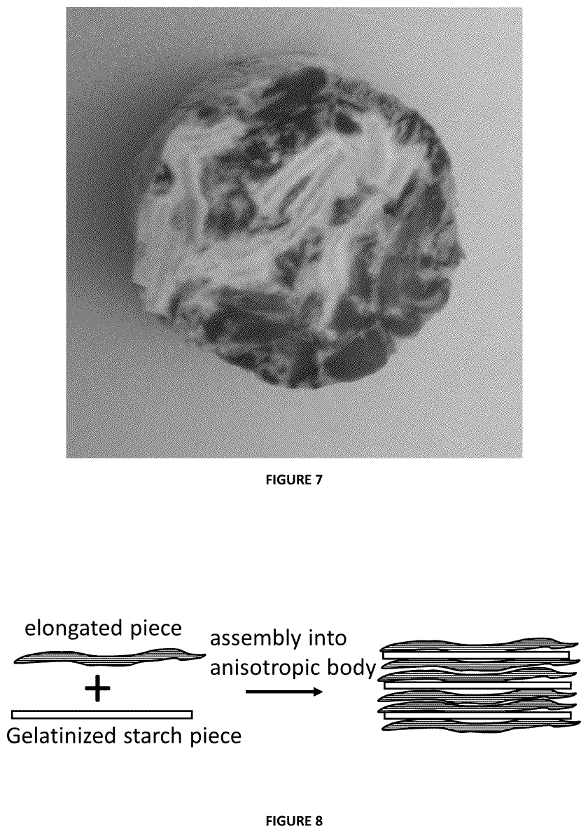

As further test samples, the same wet textured protein product comprising 20 wt % pea protein isolate and 10 wt % sunflower protein concentrate, 10 wt % pea fibers, and 60 wt % water was pulled into pieces in the range of 2-7 mm×2-7 mm×40-80 mm. The fibrous pieces were pasteurized in a vacuum bag in a 95° C. water bath for 25 minutes. A crumbly dough was formed by mixing 100% native potato starch (Agrana Stärke GMBH, Starkina 20001) with 50-65% tap water, whereby the percentages (%) refer to the total weight (100%) of native potato starch. The starch-water dough was spread out in a 1-3 mm thick layer, vacuum packed and pasteurized in a 95° C. water bath for 25 minutes. During pasteurization gelation in the starch was achieved which yielded an elastic pliable starch plate, which was cut into long strips measuring 60-70 mm×4-10 mm. The elongated pieces and the starch strips were inoculated by homogenously covering their surfaces with a powdered starter culture through mechanical mixing at a concentration of 4.8×10 viable spores per g substrate. The starter culture comprised Rhizopus oligosporus spores and organic rice flour and had a spore concentration of 8×10⁶ viable spores per g starter culture. Said pieces and starch strips were mixed and assembled into a sausage-like shape with a longitudinal directionality of the elongated pieces and starch strips parallel to the length of the sausage-like shape, leading to an elongated scaffold structure as schematically shown in FIG. 8.

The scaffolds were rolled in polyethylene film and manually compressed to decrease the distance between the pieces and increase the packing density. The polyethylene film was perforated with 1 mm wide holes every 7-10 mm in a square mesh pattern. After incubation at 30° C. and 95% relative humidity for 48 h, the surfaces and void space of the intermediate products were filled with fungal mycelium and the body was very coherent. Some of the starch granules were not fermented by the fungus and hence were filling some of the void space in between the fungal mycelium. To terminate fermentation, the product was either stored at 4° C., frozen, pasteurized in a vacuum bag submerged in a water bath at 95° C. for 25 min, or a combination thereof. The gelatinized starch phase was bound by mycelium into the product as seen in FIG. 7. Before and after preparation by pan frying the starch phase had the visual appearance and a mechanical resemblance of fat or connective tissue. The inner structure was highly fibrous, as visible in FIG. 9. During consumption of the final product after pan-frying, the mycelium contributed to a coherent, stiff texture, the fibrous elongated pieces contributed to a meat-like fibrosity and the gelatinized starch granules were melting in the mouth resulting in a sliminess known from connective tissue in meat.

### Example 7

Elongated pieces with varying thickness were all prepared from wet textured protein product comprising more than 25 wt % soy protein isolate, 15 wt % sunflower protein, and 5 wt % soy protein concentrate, and 55 wt % water. The pieces were surface-coated with glucose to achieve 10 wt % glucose concentration:
(i) at a size of 1-2 mm×1-2 mm×90 mm
(ii) at a size of 4-6 mm×4-6 mm×90 mm

Said pieces were inoculated with either Aspergillus oryzae or Rhizopus oligosporus and assembled into cylindrical bodies with a diameter of 20 mm according to Example 1 and incubated in a fermenter (Hera Cell240i) at a temperature of 30° C., and a relative humidity of 95% RH for 38 h.

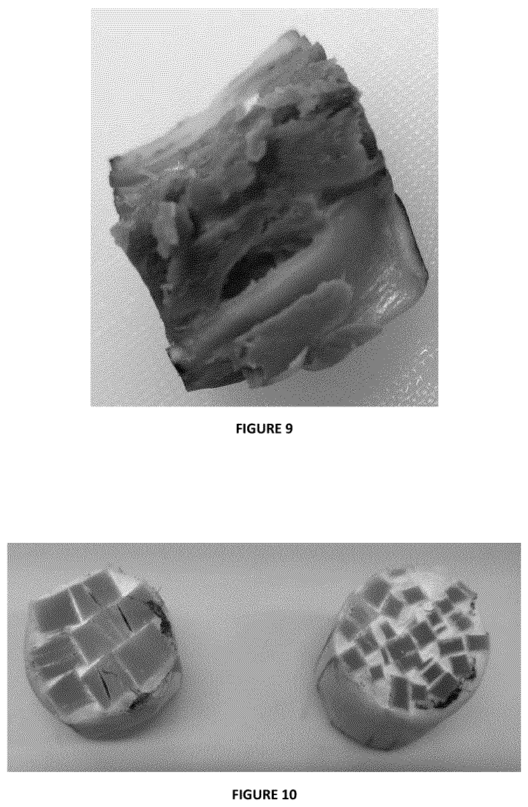

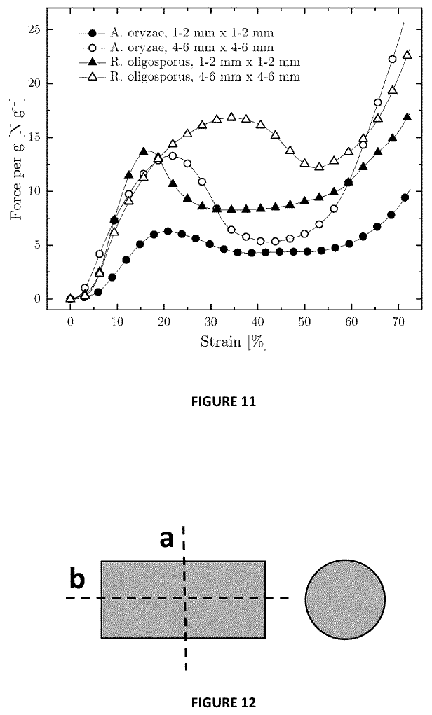

The resulting products with a diameter of approximately 20 mm were cut into samples of 20 mm in height as shown in FIG. 10. The samples were compressed in the length direction of the elongated pieces in a texture analyzer (TA.XT Plus, Stable Micro Systems) at a compression speed of 0.5 mm/s. Uniaxial compression in said direction of the piece caused buckling of the fibrous pieces. Thus, the stress response during buckling was dependent on the binding strength of the mycelium in between the pieces and mechanical properties of the pieces along their length direction and intrinsic mechanical properties. As shown in FIG. 11, varying thickness (diameter) of the pieces leads to differing stress responses in the product. This translates to the sensory perception of the product in terms of texture. Therefore, it is believed that the piece thickness (diameter) allows for tailoring the hardness, elasticity, and binding in the product.

When eaten, the texture of the product produced from the thicker pieces can be described as heterogenous, since the primary phase of chewing is dominated by the sensation of the disassembly of body into the pieces, while the ensuing phase of chewing is dominated by the overall texture sensation of the fibrous structure. The texture of the product produced from the thinner pieces is perceived as more homogenous wherein the phases between disassembly of body and chewing of fibers are less distinctive.

### Example 8

To increase the oxygen concentration in the centre of the body continuous tubular pores (channels) were created within the body to promote flow of fresh air into the interior of the body.

Wet textured protein product comprising 20 wt % pea protein isolate and 10 wt % sunflower protein concentrate, 10 wt % pea fibers, and 60 wt % water was pulled into elongated pieces in the range of 2-7 mm×2-7 mm×40-80 mm. The pieces were pasteurized in a vacuum bag in a 95° C. water bath for 25 minutes.

The elongated pieces were inoculated by homogenously covering their surfaces with a powdered starter culture through mechanical mixing at a concentration of 4.8×10⁴ viable spores per g substrate. The starter culture comprised Rhizopus oligosporus spores and organic rice flour and had a spore concentration of 8×10′⁶ viable spores per g starter culture. Said pieces were mixed and assembled into a sausage-like shape with a longitudinal direction of the elongated pieces parallel to the length of the sausage-like body, leading to an elongated scaffold structure. The scaffold was rolled in polyethylene film and manually compressed to decrease the distance between the pieces and increase the packing density. The polyethylene film was perforated with 1 mm wide holes every 5-10 mm in a square mesh pattern.

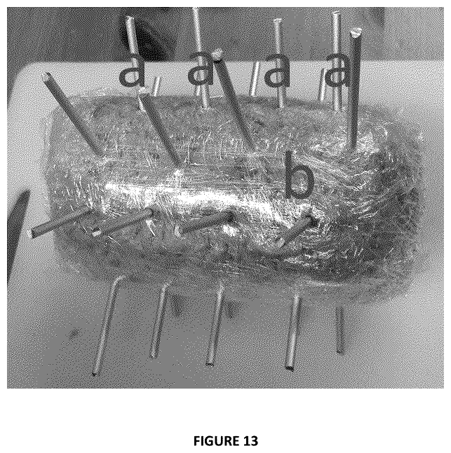

The following bodies were produced, some of which had placeholders placed within the body to produce continuous tubular pores within the body:
(i) Hollow plastic tubes of the dimensions 4×15 mm perforated with 1-2 mm sized holes at a density of 5 holes per cm², axially placed into the cylindrical body (cf. FIG. 12, “b”)
(ii) Metal rods of the dimensions: 4×15 mm, axially placed into the cylindrical body (cf. FIG. 12, “b”)
(iii) Metal rods of the dimensions: 4×15 mm, radially placed into the cylindrical body (cf. FIG. 12, “a”), as shown in FIG. 13
(iv) Metal rods of the dimensions: 2×15 mm, radially placed into the cylindrical body (cf. FIG. 12, “a”)
(v) Control sample without placeholders

Placeholders of (i) and (ii) were placed axially into the body, during the layering of the elongated pieces. Thus, the elongated pieces were arranged around the tubular placeholders. Placeholders of (iii), (iv) were radially pierced into the sausage like body after the elongated pieces had been layered, thus the fibrous pieces were penetrated by the rods.

After incubation at 40° C. for 6 h, then 30° C. for 5 h, then 24° C. for 3 h, then 20° C. for 10 h, 23° C. for 14 h while keeping the relative humidity at 95%, during a fermentation time of total 38 h, the surfaces and void space of the scaffold displayed mycelium growth. After 12 h incubation time primary mycelium growth gave the product structural integrity and the tubular placeholders (ii), (iii) and (iv) were removed from the body, leaving behind continuous tubular holes in the body to aid in the internal aeration and increase oxygen diffusion to the growing mycelium. At this time the polyethylene film was removed from the longitudinal end faces of the cylindrical body to further aid in aeration. The polyethylene film on the circumferential side of the cylindrical body was not removed. After 38 h of incubation, the surfaces and void space of the scaffold were filled with fungal mycelium and the body was very coherent. To terminate fermentation, the product was stored at 4° C., frozen, or a combination thereof.

TABLE 2
Weight, dimensions, and growth evaluation of the incubated bodies.

| | Weight | Diameter | Length | Radial | Axial |
|---|---|---|---|---|---|
| Body | [g] | [mm] | [mm] | GD | GD |
| (i) Tubes 4 mm | 815 | 85-90 | 165 | Yes | yes |
| (ii) Rod 4 mm axial | 816 | 85-90 | 160 | yes | yes |
| (iii) Rod 4 mm | 852 | 90 | 165 | yes | yes |
| radial | | | | | |
| (iv) Rod 2 mm | 847 | 85-90 | 160 | yes | yes |
| radial | | | | | |
| (v) Control | 755 | 80-90 | 150 | 20 mm | 40 mm |

GD = growth depth,
yes = growth throughout the whole diameter of the body.

The control without placeholders did not display any visibly mycelium formation in the center of the body. Strong mycelial growth was detected at a depth of 20-25 mm from the surface of the sides as noted in Table 2. Regions beneath this depth displayed sparce mycelial growth or no visible mycelium.

Bodies (i) to (iv) all displayed mycelial growth until the centre of the sample. Depending on the properties of the pores produced by the placeholders, the mycelial binding in the centre of the sample was stronger or weaker. Body (i) with perforated tubes and body (iii) with radial 4 mm rods displayed the most homogenous growth throughout the sample and good internal mycelial binding of the substrate pieces. Body (ii) with axial 4 mm rods and body (iv) with radial 2 mm rods displayed mycelial growth in the centre of the body, but the binding capacity was less strong, which demonstrated the possibility of tailoring the mycelial binding capacity with pore design. The results show that the addition of continuous tubular pores to the body, whereby the pores are connected to the outside, allows for increased internal mycelium growth compared to a body without pores.

It was observed in all samples that towards the longitudinal ends of the cylindrical body strong mycelial growth occurred at a depth of 40-45 mm measured from the end faces of the cylindrical body. This is believed to be due to increased axial oxygen diffusion into the sample due to the polyethylene film being removed after 12 h of incubation. At the same time, the removal of the polyethylene film caused the drying out of the surface on the faces of the cylindrical body, which lead to weakened mycelium growth on the surface in said region. Hence, to generate large pieces of meat analogue an additional supply of oxygen and adjustment of relative humidity is desired.

### Example 9

Wet textured protein product prepared by high moisture extrusion cooking comprising 20 wt % soy protein isolate and 10 wt % sunflower protein concentrate, 10 wt % citrus fibers, and 60 wt % water was pulled into elongated pieces in the range of 2-7 mm×2-7 mm×40-80 mm. The pieces were pasteurized in a vacuum bag in a 95° C. water bath for 25 minutes.

The elongated pieces were inoculated by homogenously covering their surfaces with a powdered starter culture through mechanical mixing at a concentration of 4.8×10⁴ viable spores per g substrate. The starter culture comprised Rhizopus oligosporus spores and organic rice flour and had a spore concentration of 8×10⁶ viable spores per g starter culture. Said pieces and starch strips were mixed and assembled into a sausage-like shape with a longitudinal directionality of the elongated pieces and starch strips parallel to the length of the sausage-like body, leading to an elongated scaffold structure. The scaffold was rolled in polyethylene film and manually compressed to decrease the distance between the pieces and increase the packing density. The cylindrical body had a diameter of 110-120 mm, a length of 160 mm, and weighed approximately 1600 g. The polyethylene film was perforated with 1 mm wide holes every 5-10 mm in a square mesh pattern. Two such bodies were formed.

A plastic tube of 4 mm diameter which was closed at its end and perforated with 0.5 mm wide holes at a density of approximately 30 holes per cm² at a length of 50 mm from its end was stuck axially into the centre of one of the bodies (cf. FIG. 12, “a”). The other body was left unaltered to function as a control. The tube was connected to an aquarium pump (EHEIM air400) which continuously pumped air into the sample at a flow rate of approximately 200 lh⁻¹. The pumped air was tempered to the temperature of the incubator and humidified to 80-100% RH. The scaffold was incubated at 30° C. and 95% relative humidity for the first 10 h, then 20° C. for another 5 h, and then at 18° C. for 14 h.

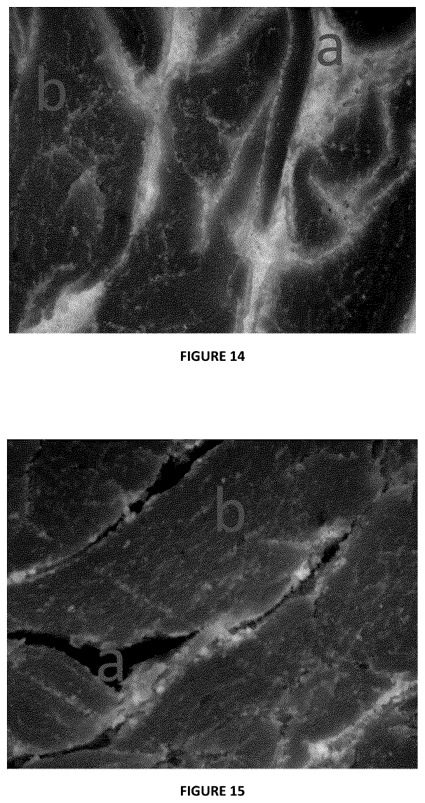

After 29 h of incubation, incubation was terminated by cooling the sample in a fridge. In the sample with continuous aeration through the inserted tube which was connected to the pump, the surfaces and void spaces of the product were homogenously filled with fungal mycelium as shown magnified in FIG. 14 and the body was very coherent and stiff. The control sample without continuous aeration displayed mycelium growth only at the edges of the sample and had no mycelial binding in the middle as shown magnified in FIG. 15. This experiment demonstrates the potential of increasing internal mycelium growth and homogenous growth of mycelium in large bodies via pressurized air injection.

Embodiments of the invention are defined by the below aspects:
1. A method of providing a fibrous fungus-containing food product involving the steps of
(i) providing one or more elongated pieces made from a wet textured protein product;
(ii) providing nutrients for fungal growth inside or around the one or more elongated pieces;
(iii) inoculating said one or more elongated pieces with at least one fungus;
(iv) forming a scaffold for mycelium growth with the one or more elongated pieces; and
(v) incubating the scaffold at growth conditions that allow for mycelium growth of the at least one fungus so that the at least one fungus forms mycelium, which grows along and through the scaffold to form a fibrous fungus-containing food product.
2. The method of aspect 1, wherein the wet textured protein product comprises at least 10 wt %, optionally at least 15 wt % protein.
3. The method of any preceding aspect, wherein the wet textured protein product is produced by subjecting a material with at least 10 wt % protein and at least 35 wt % water to shear and temperatures of above 100° C., optionally above 120° C., optionally by means of high moisture extrusion cooking (HMEC) or shear cell processing (SC)
4. The method of any preceding aspect, wherein the wet textured protein product comprises a water content of more than 35 wt %, optionally at least 40 wt %.
5. The method of any preceding aspect, wherein a density of the wet textured protein product is equal to or greater than 0.8 g/cm³, optionally greater than 0.9 g/cm³, optionally greater than 1 g/cm³.
6. The method of any preceding aspect, wherein the wet textured protein product comprises a fibrous structure in which fibers are substantially aligned with each other.
7. The method of any preceding aspect, wherein the one or more elongated pieces each have a longest dimension, e.g., a length, of equal to or greater than 1 cm, optionally equal to or greater than 2 cm and optionally equal to or greater than 4 cm,
and/or
wherein the one or more elongated pieces each have a shortest dimension, e.g., a diameter, of equal to or less than 2 cm, optionally equal to or less than 1 cm and optionally equal to or less than 0.5 cm.
8. The method of aspect 6 or 7, wherein the fibers in an elongated piece are substantially aligned with a longitudinal direction of said elongated piece.
9. The method of any of aspects 6-8, wherein fibers of a plurality of elongated pieces are aligned substantially along the same direction, or fibers of a first plurality of elongated pieces are substantially aligned along a first direction and fibers of a second plurality of elongated pieces are substantially aligned along a second direction that is different from the first direction, optionally by an angle of at least 30°.
10. The method according to any preceding aspect, wherein said wet textured protein product comprises at least 10 wt % protein selected from the group consisting of pea, soy, wheat, sunflower, pumpkin, rice, cereals, pulses, oil seeds, algae, single cells, fungi, and fermented components.
11. The method according to any preceding aspect, wherein the scaffold is formed by at least two elongated pieces, optionally at least 10 elongated pieces.
12. The method according to any preceding aspect, wherein the wet textured protein product is processed into the one or more elongated pieces by means of cutting, pulling, rolling or by soaking in liquid to an extent that the wet textured protein product disintegrates into the one or more elongated pieces.
13. The method according to any preceding aspect, wherein the one or more elongated pieces are respectively in a form of a strand or a sheet.
14. The method according to aspect 13, wherein forming the scaffold comprises assembling a plurality of strands into a bundle, rolling-up one or more sheets into a tube or a multilayer roll, or folding or stacking one or a plurality of sheets into a stack.
15. The method according to any preceding aspect, wherein forming the scaffold comprises assembling differently processed or treated elongated pieces to create a gradient of substance such as a gradient of the nutrients throughout the scaffold.
16. The method according to any preceding aspect, wherein one dimension of each elongated piece is longer than the other dimensions, optionally at least 2 times longer, optionally at least 5 times longer.
17. The method according to any of the preceding aspects, wherein the nutrients are provided inside or on the surface(s) of the one or more elongated pieces, such as by adding nutrient-containing ingredients to the high moisture extrusion cooking or shear cell process when the wet textured protein product is produced thereby, or by soaking the wet textured protein product or the one or more elongated pieces in a nutrient solution, or by coating the one or more elongated pieces with nutrient-containing liquid or powder.
18. The method according to any preceding aspect, wherein the nutrients are selected from the group of mono-, di-, or oligosaccharides acting as the nutrients for the respective fungus, optionally the nutrients being selected from the group of starch, glucose, sucrose or malted starch.
19. The method according to any preceding aspect,
   wherein one or more surfaces, optionally one or more outer surfaces, of the one or more elongated pieces are at least partly coated with carbohydrate and/or hydrocolloids, the carbohydrate and/or hydrocolloids optionally being selected from the group of starch, carrageenan, konjac, agar, alginate, xanthan, gellan gum, pectin, gelatin or a combination thereof; optionally the one or more elongated pieces are coated with starch prior to incubation, optionally with gelatinized starch;
   optionally wherein the one or more surfaces are coated with carbohydrate and/or hydrocolloid, optionally starch, to an extent that the carbohydrate and/or hydrocolloid is not fully metabolized by the fungus during incubation; and/or
   optionally the one or more elongated pieces being coated prior to incubation with at least 2 wt % carbohydrate and/or hydrocolloid, optionally starch, optionally with at least 5 wt % carbohydrate and/or hydrocolloid, optionally starch, based on a total weight of the one or more elongated pieces.
20. The method according to any of the preceding aspects, wherein the one or more elongated pieces are dried or hydrated prior to inoculation to adjust water activity to required conditions for fungal growth.
21. The method according to any of the preceding aspects, wherein the one or more elongated pieces are sterilized or pasteurized prior to inoculation.
21.a. The method according to any of the preceding aspects, wherein the surface of the elongated pieces is treated by an acid, optionally a food-grade acid, optionally lactic acid, acetic acid, malic acid, citric acid or succinic acid, optionally to reach a pH of below 6, optionally below 5, optionally not above 4.6 at the surface.
22. The method according to any of the preceding aspects, wherein the one or more elongated pieces are inoculated with the at least one fungus by mixing them with a fungus-containing liquid or powder, optionally wherein said fungus is selected from the group consisting of ascomycetes, basidiomycetes, deuteromycetes, oomycetes, and/or zygomycetes, in particular Rhizopus oligosporus, Rhizopus delemar, Rhizopus oryzae, Penicillium nalgiovense, Penicillium camemberti, Penicillium roqueforti, Aspergillus oryzae, Aspergillus luchuensis, Aspergillus sojoe, Ganoderma lucidum, Pleurotus ostreatus, Pleurotus eryngii, or a combination thereof.
23. The method according to any of the preceding aspects, wherein one or more surfaces, optionally one or more outer surfaces, of the one or more elongated pieces are prewetted prior to inoculating with fungus-containing powder.
24. The method according to any of the preceding aspects, wherein at least 3 elongated pieces are assembled with or without a mold to form the scaffold, optionally wherein the distance between neighbouring pieces is adjusted by vibration or by applying pressure or vacuum so that each piece is adjacent to a neighbouring piece with a distance of not more than 2 mm, optionally not more than 1 mm, optionally not more than 0.5 mm.
25. The method according to any of the preceding aspects, wherein at least 5, optionally at least 10 elongated pieces are assembled to form a bundle in which the elongated pieces are substantially aligned with each other, optionally wherein the scaffold comprises several bundles not being aligned to each other.
26. The method according to any of the preceding aspects, wherein one or more carbohydrate-based pieces, optionally starch-based pieces are provided in the scaffold, optionally before the incubation, wherein optionally said one or more carbohydrate-based pieces, optionally starch-based pieces are placed in between two or several elongated pieces, optionally said one or more starch-based pieces comprise at least 5 wt % starch, optionally at least 10 wt %, optionally at least 20 wt % starch based on a total weight of the one or more starch-based pieces.
27. The method according to the preceding aspect, wherein the one or more carbohydrate-based pieces, optionally starch-based pieces are respectively in a form of cube, rod, cylinder or stripe and are made from at least water and a carbohydrate selected from the group of starch, carrageenan, konjac, agar, alginate, pectin or a combination thereof, and wherein optionally the starch is gelatinized, for example by being heated above the gelatinization temperature, and are optionally cut.
28. The method according to any of the preceding aspects, wherein prior to incubation the scaffold is
at least 1 cm in at least one dimension, optionally at least 2 cm, optionally at least 4 cm, optionally between 4 cm and 15 cm; and/or
in the shortest dimension not larger than 30 cm, optionally not larger than 20 cm.
29. The method according to any of the preceding aspects, wherein the scaffold is incubated at a temperature between 4° C. and 70° C., optionally between 10° C. and 50° C., optionally between 14° C. and 20° C. or between 22° C. and 38° C., for minimum 2 hours, optionally for minimum 12 hours, optionally for the minimum duration at which mycelium is visible on the surface of the one or more elongated pieces by human eye, optionally wherein the incubation terminates prior to sporulation of the fungus or prior to formation of a fruiting body.
30. The method according to any of the preceding aspects, further comprising wrapping the scaffold in an outer layer before the incubation, wherein said layer may have holes or may be semipermeable or permeable to oxygen, optionally said outer layer is plastic foil with holes, and/or said outer layer is permeable for oxygen but not permeable for water.
31. The method according to any of the preceding aspects, wherein the scaffold is incubated at low aerobic conditions wherein the oxygen concentration is lower than under atmospheric conditions, in particular by covering the scaffold in a material so that an oxygen permeability coefficient is below 1 but above 0.
32. The method according to any of the preceding aspects, wherein holes and/or channels are made in the scaffold prior or during incubation,
optionally wherein the holes and/or channels are closed after incubation, optionally by performing a heat treatment to the fibrous fungus-containing food product or adding liquid to the fibrous fungus-containing food product.
33. The method according to any of the preceding aspects, wherein one or more placeholders, such as one or more tubes or one or more rods or one or more structures having a branched shape, are inserted into the scaffold prior to or during incubation, the one or more tubes or rods extending axially, radially or in any direction in the scaffold, optionally along the shortest dimension of the scaffold.
34. The method of aspect 33, wherein said one or more tubes or rods have a diameter of at least 0.1 mm, optionally at least 1 mm, optionally at least 2 mm and optionally not larger than 15 mm, optionally not larger than 10 mm, optionally not larger than 5 mm.
35. The method according to the preceding aspect, wherein the one or more tubes are permeable to oxygen, and/or the one or more tubes comprise an aeration tube, optionally wherein the one or more tubes comprise one or more hollow needles.
36. The method according to any of aspects 33-35, wherein the one or more tubes communicate an inner part of the scaffold with the surrounding environment.
37. The method according to any of aspects 33-36, wherein the one or more tubes are removed during or after incubation; or wherein said one or more tubes are edible and not removed prior to consumption.
38. The method according to any of aspects 33-37, wherein the one or more tubes are covered with protective culture for preventing the fungus from growing into the respective tubes.
39. The method according to any of aspects 33-38, wherein at least one tube is connected to an oxygen source, optionally to pressurized air or pressurized oxygen or to a pump.
40. The method according to the preceding aspect, wherein said pressurized air or pressurized oxygen is humidified prior to entering the scaffold, optionally to at least 80%, at least 90%, or at least 95% relative humidity;
and/or
said pressurized air or pressurized oxygen is tempered prior to entering the scaffold, optionally to at least 4° C., at least 10° C., or at least 14° C. and/or not more than 50° C., optionally not more than 45° C., optionally not more than 40° C.
41. The method according to any of aspects 33-40, wherein the one or more rods are inserted prior to or at the beginning of incubation and are removed after at least 2 hours of incubation, optionally after at least 6 hours of incubation, optionally after at least 10 hours of incubation, or optionally when mycelial growth in the scaffold is visible by human eye.
42. The method of any of the preceding aspects, further comprising a step of:
(vi) interrupting the growth of the at least one fungus, optionally by changing the temperature and/or water activity to below or above the temperature and water activity conditions required for growth of the at least one fungus, wherein said interruption is optionally performed prior to sporulation of the fungus or prior to formation of a fruiting body.
43. The method of any of the preceding aspects, further comprising a step of exposing the obtained fungus-containing food product to a liquid so that the food product absorbs the liquid, wherein said liquid is water-based or lipid-based and wherein the liquid may fully or partly fill the interstitial spaces between the elongated pieces and the mycelium filled spaces and may diffuse into the elongated pieces.
44. The method of the preceding aspect, wherein the liquid is further enriched with flavour compounds, colorants, viscosifiers, fibers, vitamins, enzymes, trace elements, salts, acids, bases, fat, carbohydrates, polysaccharides, or proteins.
45. The method of the two preceding aspects, optionally when they are in accordance with aspect 19, wherein the absorbed liquid fully or partially solubilizes or liquifies carbohydrates and/or hydrocolloids that have not been fully metabolized, optionally wherein said carbohydrates and/or hydrocolloids increase the viscosity of said absorbed liquid or gel said absorbed liquid in the interstitial spaces.
46. The method of any of the preceding aspects, wherein the obtained fungus-containing food product is cut and/or pulled into pieces or slices and/or compressed to mimic the shape of a meat product.
47. The method of any of the preceding aspects, wherein the obtained fungus-containing food product is dried prior to further use.
48. A fibrous fungus-containing food product obtained by the method of any of the preceding aspects.
49. A fibrous fungus-containing food product comprising a scaffold and mycelium of at least one fungus growing along and through the scaffold, the scaffold being formed by one or more elongated pieces made from a wet textured protein product.
50. The fibrous fungus-containing food product of aspect 47 or 48 or the method of any of aspects 1-46, wherein a first force required to pull the fibrous fungus-containing food product apart is lower than a second force required to pull the elongated piece(s) apart.
51. The fibrous fungus-containing food product of aspect 49, the first force and the second force being applied transversely to a longitudinal direction of an elongated piece.
52. The fibrous fungus-containing food product of aspect 49 or 50, the wet textured protein product comprising a fibrous structure in which fibers are substantially aligned with each other, wherein binding between the substantially aligned fibers is stronger than the binding between the elongated pieces in the fibrous fungus-containing food product.
53. The fibrous fungus-containing food product of any of aspects 47-51 or the method of any of aspects 1-46, wherein the density of the fungus-containing food product is lower than the density of the wet textured protein product, optionally the density of the fungus-containing food product being not higher than 1 g/cm³, in particular directly after incubation and prior to a subsequent step of absorbing a liquid into the food product or drying the food product.
54. The fibrous fungus-containing food product of any of aspects 47-52 or the method of any of aspects 1-46, wherein the oil absorption capacity of the fibrous fungus-containing food product is higher than that of the wet textured protein product, optionally the oil absorption capacity of the fibrous fungus-containing food product being at least 5%, optionally at least 10% of its own weight.
55. The fibrous fungus-containing food product of any of aspects 47-53, further comprising at least 0.1 wt % carbohydrates, optionally starch, and/or carbohydrate-based pieces, optionally starch-based pieces in an interstitial space of the scaffold.
56. The fibrous fungus-containing food product of any of aspects 47-54, further comprising one or more channels extending from a surface of the food product to an inside thereof, the channel having a diameter of at least 0.1 mm, optionally at least 1 mm, optionally at least 2 mm, and/or optionally not larger than 15 mm, optionally not larger than 10 mm, optionally not larger than 5 mm.
57. The fibrous fungus-containing food product of the preceding aspect, wherein the one or more channels are filled with the mycelium of the at least one fungus.
58. A fibrous fungus-containing food product comprising elongated pieces of a wet textured protein product interconnected with fungal mycelium with a protein content of at least 10 wt %, optionally at least 15 wt %, and at least 0.1 wt % starch in between the elongated pieces.
59. The fungus-containing food product of any of aspects 47-57, wherein said product is capable of absorbing at least 5%, optionally at least 10% of its own weight in oil or water or a mixture thereof.
60. The fungus-containing food product of any of aspects 47-58, comprising at least two differently appealing phases visible by human eye, wherein a first phase is substantially composed of the one or more elongated pieces and a second phase is not substantially composed of the one or more elongated pieces, optionally wherein the second phase comprises fungal mycelium, optionally the second phase comprises fungal mycelium and carbohydrates, optionally starch, or lipid.
61. The fungus-containing food product of any of aspects 47-59, wherein said food product is at least 2 cm, optionally at least 4 cm, optionally between 4 cm and 15 cm in at least one dimension; and/or in the shortest dimension not larger than 30 cm, optionally not larger than 20 cm.
62. The fungus-containing food product of any of aspects 47-60, wherein said food product comprises fungal mycelium throughout the whole product.
63. A fungus-containing food product obtainable by the method of any of aspects 1 to 46, wherein said food products contains at least 10 wt % of a plant protein, optionally at least pea protein, and at least one non-fermented starch and fungal mycelium at the interface between at least two elongated pieces.

Although the present invention has been described with reference to preferred embodiments, workers skilled in the art will recognize that changes may be made in form and detail without departing from the spirit and scope of the invention.

1. A method of providing a fibrous fungus-containing food product involving steps of
(i) providing one or more elongated pieces made from a wet textured protein product;
(ii) providing nutrients for fungal growth inside or around the one or more elongated pieces;
(iii) inoculating said one or more elongated pieces with at least one fungus;
(iv) forming a scaffold for mycelium growth with the one or more elongated pieces; and
(v) incubating the scaffold at growth conditions that allow for mycelium growth of the at least one fungus so that the at least one fungus forms mycelium, which grows along and through the scaffold to form a fibrous fungus-containing food product.

2. The method of claim 1, wherein the wet textured protein product is produced by high moisture extrusion cooking (HMEC) or shear cell processing (SC).

3. The method of claim 1, wherein the one or more elongated pieces each have a longest dimension of at least 1 cm,
or
wherein the one or more elongated pieces each have a shortest dimension of less than 2 cm.

4. The method of claim 1, wherein
i) fibers in an elongated piece are substantially aligned with a longitudinal direction of said elongated piece;
ii) fibers of a plurality of elongated pieces are aligned substantially along the same direction; or
iii) fibers of a first plurality of elongated pieces are substantially aligned along a first direction and fibers of a second plurality of elongated pieces are substantially aligned along a second direction that is different from the first direction.

5. The method of claim 1, wherein the one or more elongated pieces are respectively in a form of a strand or a sheet.

6. The method of claim 1, wherein forming the scaffold comprises assembling differently processed or treated elongated pieces to create a gradient of substance.

7. The method of claim 1,
wherein one or more surfaces of the one or more elongated pieces are at least partly coated with at least one of carbohydrate and hydrocolloid.

8. The method of claim 1, wherein one or more carbohydrate-based pieces are provided in the scaffold.

9. The method of claim 1, wherein holes or channels or a combination thereof is made in the scaffold prior to or during incubation.

10. The method of claim 1, wherein one or more tubes or rods are inserted into the scaffold prior to or during incubation, the one or more tubes or rods extending axially, radially or in any direction in the scaffold.

11. The method of claim 10, wherein at least one tube is connected to an oxygen source.

12. The method of claim 1, further comprising a step of exposing the obtained fungus-containing food product to a liquid so that the food product absorbs the liquid, wherein said liquid is water-based or lipid-based.

13. A fibrous fungus-containing food product comprising a scaffold and mycelium of at least one fungus grown along and through the scaffold, the scaffold being formed by one or more elongated pieces made from a wet textured protein product.

14. The fungus-containing food product of claim 13, wherein said fungus-containing food product is composed of at least two different phases distinguishable by human eye.

15. The fibrous fungus-containing food product of claim 13, wherein at least one of below i) to iii) are fulfilled,
i) a first force required to pull the fibrous fungus-containing food product apart is lower than a second force required to pull the wet textured protein product apart;
ii) the density of the fungus-containing food product is lower than the density of the wet textured protein product;
iii) the oil absorption capacity of the fibrous fungus-containing food product is higher than that of the wet textured protein product.

16. The method of claim 1, wherein the wet textured protein product comprises a water content of more than 35 wt %.

17. The method of claim 7, wherein the one or more surfaces are coated with at least one of carbohydrate and hydrocolloid to an extent that the carbohydrate or hydrocolloid is not fully metabolized by the fungus during incubation.

18. The method of claim 11, wherein at least one tube is connected to pressurized air or pressurized oxygen or to a pump.

19. The fungus-containing food product of claim 14, wherein a first phase is substantially composed of one or more elongated pieces and a second phase is not substantially composed of the one or more elongated pieces.

20. The fungus-containing food product of claim 19, wherein the second phase comprises fungal mycelium and carbohydrates.
